(19) United States
(12) Patent Application Publication
(10) Pub. No.: US 2007/0056279 A1
(43) Pub. Date: Mar. 15, 2007

(54) Hydraulic control system

(75) Inventor: Bon Seok Koo, Kyungsangnam-do (KR)

Correspondence Address: LADAS & PARRY, 26 WEST 61ST STREET, NEW YORK, NY, 10023, US

(73) Assignee: VOLVO CONSTRUCTION EQUIPMENT HOLDING SWEDEN AB

(21) Appl. No.: 11/484,913

(22) Filed: Jul. 12, 2006

(30) Foreign Application Priority Data
Sep. 15, 2005 (KR) 10-2005-0085992

(51) Int. Cl. F16D 31/02

(52) U.S. Cl. 60/452

(57) ABSTRACT

Disclosed is a hydraulic control system that can minimize pressure generated by a resilient member of a second flow control device when a hydraulic fluid discharged from a hydraulic pump constantly flows to a tank through a bypass passage while a shifting valve is in the neutral position, and also can control the pressure generated by the resilient member, if necessary. The hydraulic control system includes a hydraulic chamber for applying resilient force to the resilient member provided on one side of the second flow control device. The hydraulic chamber is adapted to operate in response to an automatic deceleration signal pressure Pi when operation of the shifting valves is detected. In the case where there is no need to control the flow rate of the hydraulic fluid flowing through the bypass passage by using the second flow control device, i.e., if an input signal Pi is not applied, the resilient force of the resilient member applied to the second flow control device is set to the minimum level, thereby minimizing the pressure loss when the hydraulic fluid flows through the second flow control device.

### CROSS-REFERENCE TO RELATED APPLICATION

This application is based on and claims priority from Korean Patent Application No. 10-2005-85992, filed on Sep. 15, 2005, the disclosure of which is incorporated herein in its entirety by reference.

### BACKGROUND OF THE INVENTION

1. Field of the Invention

The present invention relates to a hydraulic control system, and more particularly, to a hydraulic control system that can minimize pressure generated by a resilient member of a flow control device when a shifting valve is in a neutral position, thereby reducing the pressure loss of hydraulic fluid passing through the flow control device, and also can variably control the flow control device in response to an automatic deceleration signal pressure when operation of the shifting valve is detected.

2. Description of the Prior Art

FIG. 1 shows a hydraulic circuit diagram illustrating the construction of a conventional hydraulic control system, and FIG. 2 is a graph depicting a pump hydraulic diagram of FIG. 1.

Referring to FIG. 1, the conventional hydraulic control system includes a variable displacement type main hydraulic pump 4 connected to a hydraulic fluid supply passage 2, a plurality of actuators (not shown), and a plurality of shifting valves 10 and 12 arranged in parallel to the hydraulic fluid supply passage 2 between the variable displacement type main hydraulic pump 4 and the actuators.

First flow control devices 20 and 22 and a load pressure signal passage 30 are interposed between the shifting valves 10 and 12 and the actuators, and the load pressure signal passage 30 forms a passage for guiding a portion of a hydraulic fluid fed by the shifting operation of the shifting valves 10 and 12 to a tank T via the first flow control devices 20 and 22.

A second flow control device 50 is provided on one side of the bypass passage 40 branching from the hydraulic fluid supply passage 2 and is switched into an open direction or a closed direction, depending upon a pressure difference among the pressure in the load pressure signal passage 30, the pressure in the resilient member 42, and the pressure in the bypass passage 40 side, thereby controlling the flow rate of the hydraulic fluid flowing through the bypass passage 40.

Also, the bypass passage 40 is provided with a pressure generator 60 for generating pressure on the downstream-most side of the bypass passage, and the main hydraulic pump 4 is provided with a hydraulic-pump flow control device 70 for controlling the discharging capacity of the hydraulic pump on one side of the main hydraulic pump 4. Therefore, the flow rate of the hydraulic fluid discharged from the main hydraulic pump 4 is controlled by regulating the inclination angle of a swash plate in the main hydraulic pump 4 in accordance with the pressure in a pressure signal line 62.

The pressure generated by the pressure generator 60 is applied to the hydraulic-pump flow control pump 70 through the pressure signal line 62, so that the flow rate of the hydraulic fluid discharged from the variable displacement type main hydraulic pump 4 can be controlled in accordance with the pressure.

During operation, when the shifting valves 10 and 12 are under the neutral condition, the hydraulic fluid passing through the bypass passage 40 is pressurized by the pressure generator 60, and thus, the pressure is generated in the pressure signal line 62 so that the flow rate of the hydraulic fluid discharged from the main hydraulic pump 4 is minimized by the pressure.

When the shifting valves 10 and 12 are switched from the neutral position, the flow rate of the hydraulic fluid passing through the second flow control device 50 is varied by the pressure in the load pressure signal passage 30 and the pressure in the bypass passage 40, and the flow rate of the hydraulic fluid discharged from the variable displacement main hydraulic pump 4 is controlled by the varied pressure in the pressure signal line 62.

The conventional hydraulic control system has the following disadvantages.

As can be seen from the pump pressure diagram of FIG. 2, when the hydraulic fluid flows to the tank through the bypass passage 40 while the shifting valves 10 and 12 are in the neutral position, the hydraulic fluid flows to the tank intact as much as the pressure (for example, about 15 to 20 bar) is generated by the resilient member 42 of the second flow control device 50 and the pressure is generated by the throttling part of the pressure generator 60, and thus the energy efficiency is degraded.

### SUMMARY OF THE INVENTION

Accordingly, the present invention has been made to solve the above-mentioned problems occurring in the prior art, and an object of the present invention is to provide a hydraulic control system that can minimize pressure generated by a resilient member of a second flow control device when the hydraulic fluid discharged from a hydraulic pump constantly flows to a tank through a bypass passage while a shifting valve is in a neutral position, and also can control the pressure generated by the resilient member, if necessary.

In order to accomplish the object, there is provided a hydraulic control system including a variable displacement type main hydraulic pump connected to a hydraulic fluid supply passage on one side thereof; a plurality of actuators driven by hydraulic fluid discharged from the main hydraulic pump; shifting valves connected in parallel to the hydraulic fluid supply passage between the main hydraulic pump and the actuators; first flow control device interposed between the shifting valves and the actuators; a load pressure signal passage guiding a portion of the hydraulic fluid fed by the shifting operation of the shifting valves to a tank via the first flow control devices; a second flow control device provided on one side of a bypass passage branching from the hydraulic fluid supply passage that is switched into an open direction or a closed direction, depending upon a pressure difference among pressure in the load pressure signal passage, pressure in the resilient member, and pressure in the bypass passage side, to control the flow rate of the hydraulic fluid flowing through the bypass passage; a pressure generator, provided on the downstream-most side of the bypass passage, for generating pressure; a pressure signal line pressurized by the pressure generator; a hydraulic-pump flow control device provided on one side of the main hydraulic pump for controlling the flow rate of the hydraulic fluid discharged from the main hydraulic pump by regulating the inclination angle of a swash plate in the main hydraulic pump in accordance with pressure in a pressure signal line; and a hydraulic chamber provided on one side of the second flow control device for applying resilient force to the resilient member, wherein when an external input signal is applied to the hydraulic chamber, the second flow control device is variably controlled.

Preferably, the input signal is an automatic deceleration signal generated when the shifting operation of the shifting valve is detected.

With the construction of the present invention, if the hydraulic fluid flows to the tank through the bypass passage when the shifting valve is in the neutral position, the pressure loss generated by the resilient member of the second flow control device can be minimized. If necessary, since the pressure is applied to the resilient member, it is possible to control the flow rate of the hydraulic fluid through the bypass, thereby increasing the energy efficiency.

### BRIEF DESCRIPTION OF THE DRAWINGS

The above and other objects, features and advantages of the present invention will be more apparent from the following detailed description taken in conjunction with the accompanying drawings, in which:

FIG. 1 is a hydraulic circuit diagram illustrating the construction of a conventional hydraulic control system;

FIG. 2 is a graph depicting a pump hydraulic diagram of FIG. 1;

FIG. 3 is a hydraulic circuit diagram illustrating the construction of a hydraulic control system according to a preferred embodiment of the present invention; and

FIG. 4 is a graph depicting a pump hydraulic diagram of FIG. 3.

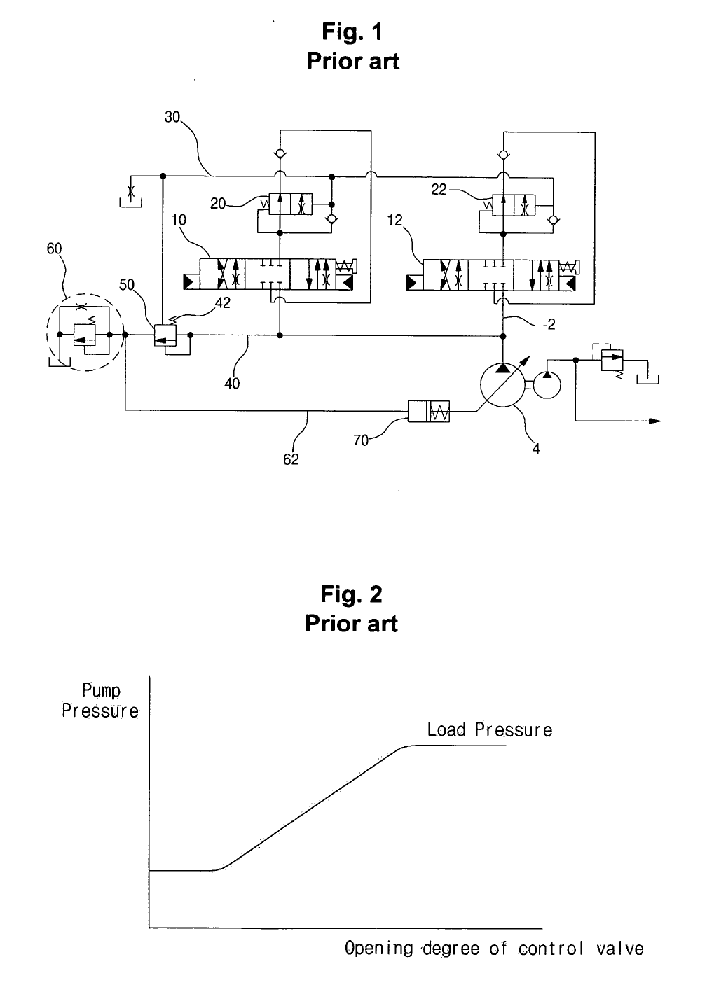

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

The construction of a hydraulic control system according to the present invention will now be described in detail with reference to preferred embodiments.

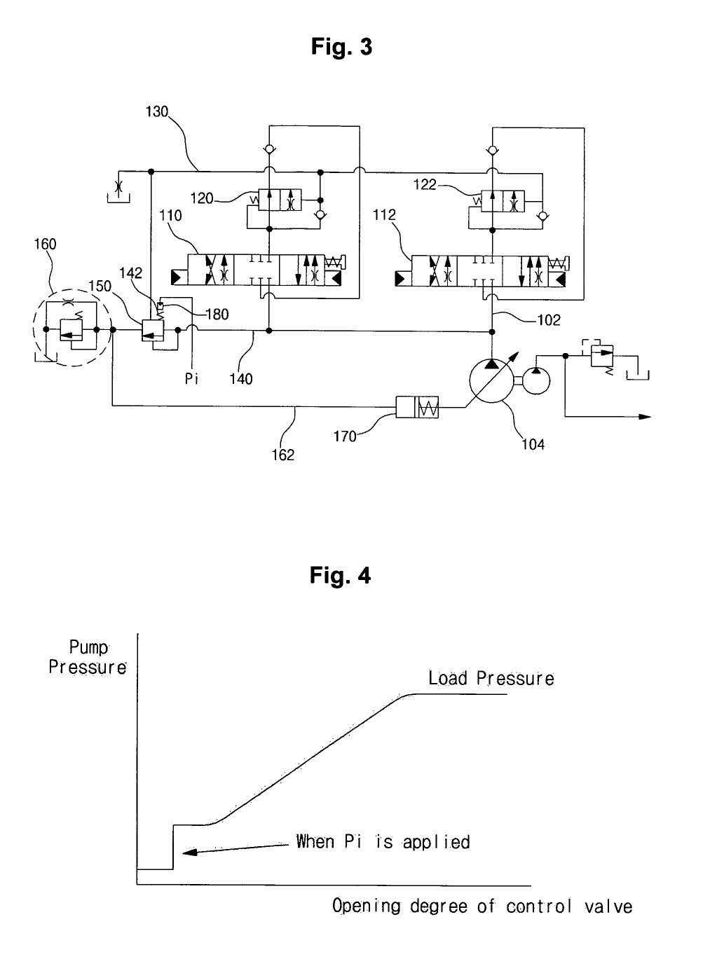

FIG. 3 is a hydraulic circuit diagram illustrating the construction of a hydraulic control system according to a preferred embodiment of the present invention, and FIG. 4 is a graph depicting a pump hydraulic diagram of FIG. 3.

Referring to FIG. 3, the hydraulic control system includes a variable displacement type main hydraulic pump 104 connected to a hydraulic fluid supply passage 102 on one side thereof, a plurality of actuators (not shown) driven by a hydraulic fluid discharged from the main hydraulic pump 104, shifting valves 110 and 112 connected in parallel with the hydraulic fluid supply passage 102 between the main hydraulic pump 104 and the actuators, first flow control devices 120 and 122 interposed between the shifting valves 110 and 112 and the actuators, a load pressure signal passage 130 for guiding a portion of the hydraulic fluid fed by the shifting operation of the shifting valves 110 and 112 to a tank T via the first flow control devices 120 and 122, a second flow control device 150 provided on one side of a bypass passage 140 branching from the hydraulic fluid supply passage 102, and switched into an open direction or a closed direction depending upon a pressure difference among the pressure in the load pressure signal passage 130, the pressure in the resilient member 142, and the pressure in the bypass passage 140 side to control the flow rate of the hydraulic fluid flowing through the bypass passage 140, a pressure generator 160 provided on the downstream-most side of the bypass passage 140 for generating pressure, a pressure signal line 162 pressurized by the pressure generator 160, a hydraulic-pump flow control device 170 provided on one side of the main hydraulic pump 104 for controlling the flow rate of the hydraulic fluid discharged from the main hydraulic pump 104 by regulating an inclination angle of a swash plate in the main hydraulic pump 104 in accordance with the pressure of a pressure signal line 162.

The hydraulic control system of the present invention includes a hydraulic chamber 180 for applying resilient force to the resilient member 142 provided on one side of the second flow control device 150. The hydraulic chamber 180 is adapted to operate in response to an automatic deceleration signal pressure Pi when operation of the shifting valves 110 and 112 is detected.

The operation of the hydraulic control system constructed as described above will now be described in detail with reference to FIG. 3.

When the shifting valves 110 and 112 are in the neutral position, the hydraulic fluid passing through the bypass passage 140 is pressurized by the pressure generator 160, and thus the pressure is generated in the pressure signal line 162, so that the flow rate of the hydraulic fluid discharged from the main hydraulic pump 104 is minimized by the pressure.

When the shifting valves 110 and 112 are switched from the neutral position, the flow rate of the hydraulic fluid passing through the second flow control device 150 is varied by the pressure in the load pressure signal passage 130 and the pressure in the bypass passage 140, and the flow rate of the hydraulic fluid discharged from the variable displacement main hydraulic pump 104 is controlled by the varied pressure in the pressure signal line 162.

Therefore, in the case where there is no need to control the flow rate of the hydraulic fluid flowing through the bypass passage 140 by using the second flow control device 150, i.e., if an input signal Pi is not applied, the resilient force of the resilient member 142 applied to the second flow control device 150 is set to the minimum level, thereby minimizing the pressure loss when the hydraulic fluid flows through the second flow control device 150.

While, in the case where it is necessary to control the flow rate of the hydraulic fluid flowing through the bypass passage 140 by using the second flow control device 150, i.e., if the shifting valves 110 and 112 are switched and the hydraulic chamber 180 of the second flow control device 150 receives an automatic deceleration signal pressure Pi detecting the shifting operation of the shifting valves 110 and 112, the resilient force of the resilient member 142 applied to the second flow control device 150 is further increased, so that the second flow control device 150 can control the flow rate by using the bypass passage 140. Therefore, the function of controlling the flow rate according to the related art can be achieved intact.

As described above, the present invention can minimize the pressure generated by the resilient member of the flow control device when the shifting valve is in the neutral position, thereby reducing the pressure loss of the hydraulic fluid passing through the flow control device, and also can control the flow rate of the hydraulic fluid through the bypass by installing a hydraulic chamber for increasing the resilient force of the resilient member on one side of the flow control device, if necessary.

From the foregoing, it will be apparent that the present invention provides the advantages that if the hydraulic fluid flows to the tank through the bypass passage when the shifting valve is in the neutral position, the pressure loss generated by the resilient member of the second flow control device can be minimized. If necessary, since the pressure is applied to the resilient member, it is possible to control the flow rate of the hydraulic fluid through the bypass, thereby increasing the energy efficiency.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A hydraulic control system comprising:
a variable displacement main hydraulic pump connected to a hydraulic fluid supply passage on one side thereof;
a plurality of actuators driven by a hydraulic fluid discharged from the main hydraulic pump;
shifting valves connected in parallel to the hydraulic fluid supply passage between the main hydraulic pump and the actuators;
first flow control devices interposed between the shifting valves and the actuators;
a load pressure signal passage guiding a portion of the hydraulic fluid fed by the shifting operation of the shifting valves to a tank via the first flow control devices;
a second flow control device provided on one side of a bypass passage branching from the hydraulic fluid supply passage, and switched into an open direction or a closed direction, depending upon a pressure difference among pressure in the load pressure signal passage, pressure in the resilient member, and pressure in the bypass passage side, to control the flow rate of the hydraulic fluid flowing through the bypass passage;
a pressure generator, provided on the downstream-most side of the bypass passage, for generating pressure;
a pressure signal line pressurized by the pressure generator;
a hydraulic-pump flow control device, provided on one side of the main hydraulic pump, for controlling the flow rate of the hydraulic fluid discharged from the main hydraulic pump by regulating the inclination angle of a swash plate in the main hydraulic pump in accordance with pressure in a pressure signal line; and
a hydraulic chamber provided on one side of the second flow control device for applying resilient force to the resilient member;
wherein when an external input signal is applied to the hydraulic chamber, the second flow control device is variably controlled.

2. The hydraulic control system as claimed in claim 1, wherein the input signal is an automatic deceleration signal generated when shifting operation of the shifting valve is detected.
